(19) United States
(12) Patent Application Publication
(10) Pub. No.: US 2022/0322613 A1
(43) Pub. Date: Oct. 13, 2022

(54) Modular Planting System

(71) Applicant: Urban Harvest Company Limited, Hong Kong (CN)

(72) Inventors: Sai Cheung Osbert Lam, Hong Kong (CN); Philip Pang, Hong Kong (CN); Wai Kwong Tang, Hong Kong (CN)

(21) Appl. No.: 17/639,527

(22) PCT Filed: Sep. 2, 2020
(86) PCT No.: PCT/IB2020/058147

§ 371 Date: Mar. 1, 2022

(30) Foreign Application Priority Data
Sep. 3, 2019 (HK) 19129090.7

(51) Int. Cl. A01G 9/02

(52) U.S. Cl. CPC A01G 9/028

(57) ABSTRACT

A modular planting system comprising a plurality of container units to receive therein a growing medium and one or more plants or plant material, the container unit being configured such that adjacent abutting container units define at least one or more voids therebetween; a frame with a plurality of engagement projections which extend at least partially into the at least one or more voids defined between adjacent abutting container units to maintain said container units in the abutting arrangement and positioned above apertures defined in the support frame member; and a water impermeable base that supports the frame spaced apart by a predetermined distance from an upper surface of the water impermeable base.

### FIELD

The present disclosure relates to a planting system, particularly a modular planting system with a self-watering mechanism.

### BACKGROUND

Tending to plants in a garden is an activity which can offer a multitude of benefits to humans, especially in a heavily urbanised environment. Gardening usually involves physical exercise in the outdoors and is a good physical and mental counterbalance to workers of developed countries who spend sedentary time in an office in front of a computer screen. In addition, in developing countries, raising small crops can provide essential sustenance for families and communities.

However, accessing ground space for gardens is very much a luxury for people living in a city environment, especially urbanised and crowded cities with limited living space, such as Hong Kong. In both urbanised and crowded cities and in less densely populated developing areas, soils may be generally unsuitable for growing plants, for a variety of reasons including contamination, excess or lack of water or low nutritional content of soil or other growing medium.

Although community gardens or allotments can be provided in such situations, such community gardens have significant inconvenience. For example, physical space and the time period for designated space in such gardens may also be limited. This means a prospective gardener may not have the whole experience of growing from seeds to products for plants which have a lengthy growing time, or may grow too much of one particular type of plant (e.g. herb) for their needs at a particular time. As the cost of land is likely to be relatively high in cities, it is also likely that locations of the community gardens or allotments are remote from most prospective gardener's homes, thus requiring frequent travel often carrying bulky garden supplies.

Some systems have been developed to enable people to have a gardening experience closer to home, for example on a balcony or roof. Such systems generally include multiple containers of growing medium (such as soil) and plants, and may contain a water reservoir. However, such planting system may have fixed size, or may comprise multiple individual containers, and in either case may be heavy or otherwise difficult to move. Typically if multiple pots are used they are a collection of sizes and shapes purchased at different times and which may be aesthetically unattractive. Typically, with such systems, it may be difficult to include additional types of plants or move such plants during the planting period. In some cases, watering can be another problem, for example gardeners may be busy or away from home for several days.

Accordingly there is a need in the art to provide a planting system which addresses or at least ameliorates the above problems.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a modular planting system. The modular plating system comprises a plurality of container units for receiving therein growing medium and one or more plants or plant material, said containers being configured such that adjacent abutting containers define at least one or more void therebetween; a supporting member receivable inside each of the plurality of container units having at least a lower surface at a first height and an upper surface at a second height, wherein the second height is different from and greater than the first height; and at least one of surfaces are water permeable; a water impermeable base defining a volume for receiving therein the plurality of containers; and a plurality of engagement projections extending from the water impermeable base configured to receive at least one supporting member of at least one container unit so as to maintain said at least one container unit in a predetermined arrangement wherein the lower surface of the supporting member is spaced apart from an upper surface of the water impermeable base by a predetermined separation distance.

The cross section of the containers and the supporting members received therein are substantially cross shaped. Optionally, the container units are sized as contiguous multiples of a single container unit. The container units are configured as double, triple and quadruple multiples of a single container unit.

Optionally, the container units are configured as double, triple and quadruple multiples of a single container unit along one direction and one single container unit in a direction orthogonal thereto. The plurality of containers are configured such that the containers are multiples of a common unitary container so as to substantially extend along the predetermined dimensions of the base.

The modular planting system may further comprise a member configured for interengaging adjacent modular planting systems and defining a pathway for passive fluid communication between adjacent modular planting systems. The system may further comprise a block member for reinforcing the at least one or more voids between adjacent container units.

Optionally, the modular system may comprise a single container unit having a size of 95 mm in width, 95 mm in length and 64 mm in height and having a cross sectional shape of a rectangle from which 16.0 mm squares have been removed from each corner thereof.

In accordance with a second aspect of the present disclosure, there is provided another modular planting system. The modular planting system comprises a plurality of container units for receiving therein growing medium and one or more plants or plant material, said container unit being configured such that adjacent abutting container units define at least one or more void therebetween; a frame with a plurality of engagement projections extending at least partially into the at least one or more voids defined between adjacent abutting container units to maintain said container units in the abutting arrangement and positioned above apertures defined in the support frame member; a water impermeable base configured for supporting the frame spaced apart by a predetermined distance from an upper surface of the water impermeable base. At least one or more of the plurality of container units includes therein a supporting member defining at least an upper surface at a first height and a lower surface at a second height. The second height is different from and greater than the first height; and at least one of surfaces are water permeable and the supporting member extends through the apertures defined in the frame toward the water impermeable base. The cross section of the containers and the supporting members received therein are substantially cross shaped.

Optionally, the container units are sized as contiguous multiples of a single container unit. The container units are sized n times a single container unit, wherein n is a natural number from 1-4.

Optionally, the engagement projections have a predetermined length such that when received in the void defined between adjacent abutting containers the engagement projections extend near to the level of the uppermost surface of the plurality of containers.

Optionally, the water impermeable base may include at least two recesses therein sized and spaced apart for receiving the tines of a forklift therein.

Optionally, the modular planting system may further include a block member for reinforcing the at least one or more voids between adjacent containers.

Optionally, the water impermeable base may include an aperture formed therein for fluid communication with an adjacent modular planting system. There are removable side members extending between corner portions. The corner portions include at least one aperture for receiving either a least one pole or a locating member extending from a water impermeable base of another modular planting system.

Optionally, the modular planting system may comprise a single container unit having cross sectional shape of a square of 680 mm in width and 680 mm in length and having 297 mm in height.

Advantageously, the planting systems of the present disclosure allow for easy assembly, disassembly and transportation, especially in a stackable configuration.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

Preferred embodiments of the present disclosure will be explained in further detail below by way of examples and with reference to the accompanying drawings, in which:

FIG. 1 depicts a perspective view of an exemplary modular planting system (3 units×3 units) in an assembled state with containers inserted.

FIG. 2A depicts an exemplary container unit in an assembled state.

FIG. 2B depicts an exemplary base configured to fit the exemplary container unit of FIG. 2A.

FIG. 2C depicts a supporting member configured to be received in the exemplary container unit of FIG. 2A.

FIG. 2D depicts the exemplary container unit of FIG. 2A with openings on the top and bottom.

FIG. 3 depicts a further embodiment of a container unit with an extended size (1 unit×2 units long).

FIG. 4 depicts a further embodiment of a container unit with a further extended size (1 unit×3 units long).

FIG. 5 depicts a perspective view of the water impermeable base of the modular planting system of FIG. 1.

FIG. 6A depicts a further embodiment of the modular planting system (2 units×2 units).

FIG. 6B depicts a perspective view of the water impermeable base of the modular planting system of FIG. 6A.

FIG. 7A depicts an arrangement comprising multiple modular planting systems of FIG. 1.

FIG. 7B depicts another arrangement comprising multiple modular planting systems of FIG. 6A.

FIG. 8A depicts an exemplary member configured for interengaging adjacent container units in the arrangement of FIG. 7A.

FIG. 8B depicts an alternate exemplary member configured for interengaging adjacent container units in the arrangement of FIG. 7A.

FIG. 8C depicts an exemplary block member for reinforcing a void between adjacent container units in the arrangement of FIG. 7A.

FIG. 8D depicts a further exemplary block member for reinforcing the voids between adjacent container units in the arrangement of FIG. 7A.

FIG. 9A to FIG. 9G depict exemplary stacking arrangements of the modular planting systems of FIG. 1, FIG. 6A and FIG. 7A.

FIG. 10A depicts a perspective view of a further embodiment of the modular planting system.

FIG. 10B depicts a cross section view of the modular planting system of FIG. 10A.

FIG. 11A depicts an exemplary water impermeable base for use in the modular planting system of FIG. 10A.

FIG. 11B depicts an exemplary frame with a plurality of engagement projections and apertures for use in the modular system of FIG. 10A.

FIG. 11C(i) depicts a supporting member of the exemplary container unit of the modular system of FIG. 10A having a first depth.

FIG. 11C(ii) depicts a supporting member of the exemplary container unit of the modular system of FIG. 10A having a second depth.

FIG. 11D depicts an exemplary joint member.

FIG. 11E is an exemplary block for reinforcing the exemplary container unit.

FIG. 12A depicts a further exemplary modular planting system with an extended size.

FIG. 12B depicts a perspective view of a water impermeable base of the further exemplary modular planting system of FIG. 12A.

FIG. 13A depicts a further exemplary modular planting system with an even further extended size.

FIG. 13B depicts a perspective view of a water impermeable base of the further exemplary modular planting system of FIG. 13A.

FIG. 14 depicts another arrangement of a modular planting system.

FIG. 15A depicts a perspective view of a water impermeable base of the exemplary modular planting system of FIG. 14.

FIG. 15B depicts a frame with a plurality of apertures of the exemplary modular planting system of FIG. 14.

FIG. 15C depicts a cap member of the still further exemplary modular planting system of FIG. 14.

FIG. 15D depicts a pot member of the still further exemplary modular planting system of FIG. 14.

FIG. 16A depicts a still further exemplary modular planting system with an extended size (two times in one direction) compared to the modular planting system of FIG. 14.

FIG. 16B depicts a perspective view of a water impermeable base of the still further exemplary modular planting system of FIG. 16A.

FIG. 17A depicts a still further exemplary modular planting system with an extended size (2 units×2 units).

FIG. 17B depicts a perspective view of a water impermeable base of the exemplary modular planting system of FIG. 17A.

FIG. 18 depicts an arrangement of the modular planting systems in situ in an exemplary configuration.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

The disclosed technology addresses the need in the art for modular planting systems which are convenient, easy to use and easy to relocate, especially in stackable configurations.

Referring to the drawings, there is shown a number of exemplary arrangements of variations of the modular planting system according to the present disclosure.

As used herein “growing medium” may include any media which provide physical support for plant growth, space for root growth and provision of necessities such as water, air and nutrients. For example, this may include natural soil, artificial soil, wood fibres or the like, with either or both organic and inorganic materials such as vermiculite, perlite or similar; and including blends thereof.

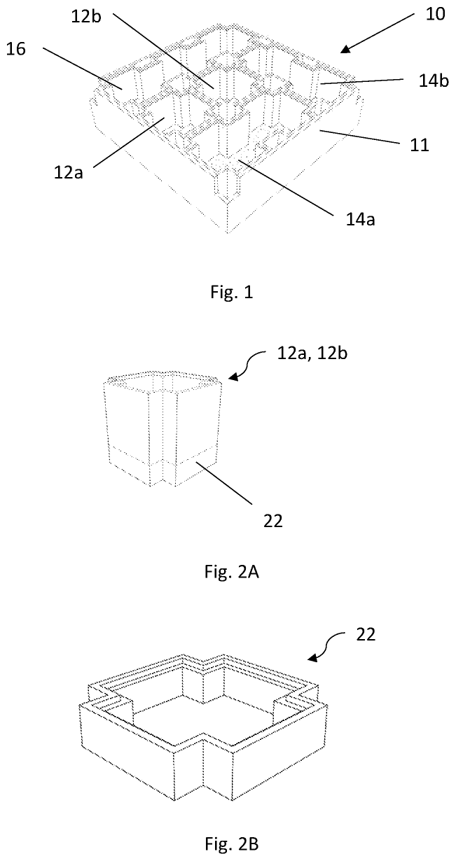

There is depicted in FIG. 1 a first embodiment of a modular planting system 10 according to the present disclosure. The modular planting system 10 depicted comprises a plurality of container units as follows: container units 12a, 12b (a single container unit), 14a, 14b (a double container unit) and 16 (a single row triple container unit). In an exemplary arrangement, the modular planting system of FIG. 1 may be 295 mm in length and similar dimension in width. As is discussed in detail further, it would be appreciated that the configuration depicted is exemplary only, and multiple arrangements of the various container units in various sizes could be utilized without departing from the scope of the present invention.

The container unit enclosed by sidewalls 11 of the modular planting system 10 and rest on a base (not visible in the Figure).

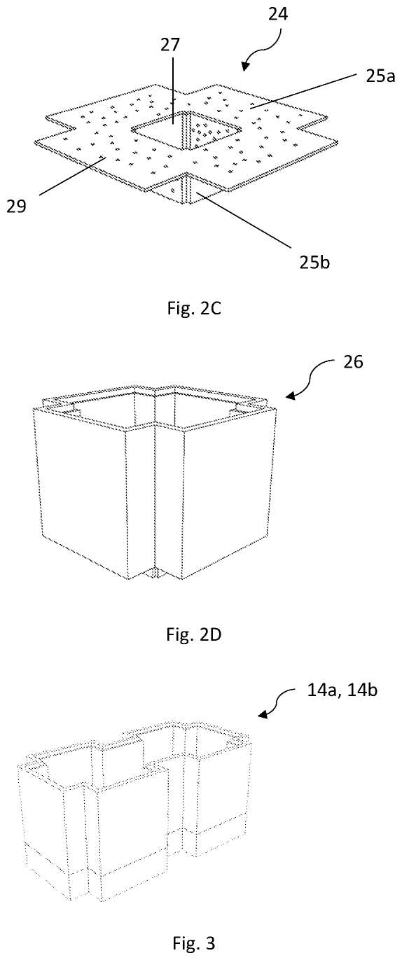

Referring now to FIG. 2A, there is depicted an exemplary container unit 12a, 12b which may be received in the modular planting system 10 in an assembled state.

The modular container unit 12a, 12b may comprise an optional base or tray 22 as depicted in FIG. 2B, a supporting member 24 which is configured to be received in the container unit (FIG. 2C) and a sidewall unit 26 of the container (FIG. 2D), all of which together may comprise the exemplary container unit 12a, 12b (and other sizes depicted in a similar arrangement). These container units 12a, 12b may be used independently in which case they may include the optional base or tray 22; or may be used together with other container units and a larger water impermeable base as is discussed in further detail below.

It would be appreciated that the container units could be manufactured from a variety of materials, including plastic, fibreglass resin, ceramic, cement or other suitable material according to the aesthetic and loading characteristics desired without departing from the scope of the present disclosure.

As shown in FIG. 2C, there is a support member 24 which includes an upper surface 25a, and a lower surface 25b which are located at different heights. As depicted, the lower surface 25a is separated from the upper surface 25b so as to form a well or hole 27 in which additional planting material (growing medium and roots of the plants may be received). In an exemplary arrangement, the supporting member 24 is around 20 mm in height. There is also included a number of apertures 29 formed in the support member 24 such that roots of the plants contained in the container units may extend therethrough. These apertures may be formed on the upper or lower surfaces or on any of the other surfaces between. It would be appreciated that these apertures permit the flow of water therethrough, although depending on the material of the support member and the desired amount of permeability, no apertures or less or more apertures than depicted may be included for enhancing the permeability.

However, it would be appreciated that such apertures 29 would be sized appropriately so as to ensure that the bulk of the growing medium is retained in the container unit when in use.

The shape of the container unit 12a, 12b depicted in FIG. 2A to FIG. 2D is in a generally cross shape arrangement with a void formed at each of the four corners of the cross. In an exemplary arrangement, the container units may be 95 mm long from one side of the cross to the other and a similar dimension wide and 85 mm in height with the base 22 being 21 mm in height. As shown, the single container unit has a size of 95 mm in width, 95 mm in length and 64 mm in height and having a cross sectional shape of a rectangular prism from which 16.0 mm squares have been removed from each corner.

However, it would be appreciated that other dimensions would also be possible and would fall within the scope of the disclosure. As we will discuss in further detail, it would be appreciated that when two or more of these containers are arranged in an abutting arrangement, a void is defined between the adjacent containers.

Referring now to FIG. 3, there is depicted a further embodiment of a container unit shown in FIGS. 2A-2D, an extended size which is a twice the size of the single container unit 12a. That is, the container unit depicted in FIG. 3 comprises essentially two adjacent container units of FIG. 2A to FIG. 2D, with the internal separation wall removed, and with an optional tray 22 also included in the assembled view shown. In an exemplary arrangement, the container units of FIG. 3 may be 190 mm in length from one side of the cross to the other and 95 mm in width. As shown, it would be appreciated that the container unit 14a, 14b of FIG. 3 is generally in the shape of adjoining crosses, with voids defined at the middle and in corners of the ends.

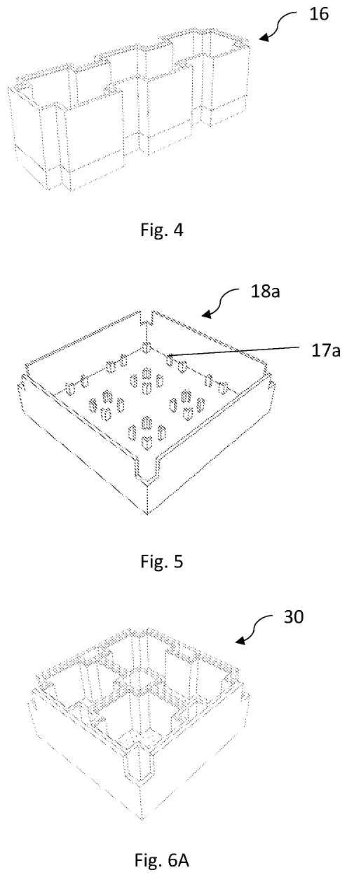

Referring now to FIG. 4, there is depicted a further embodiment of an exemplary container unit 16, with a further extended size. In this case, the container unit comprises essentially three adjacent adjoin container units depicted in FIGS. 2A to 2D, with the separating walls removed therefrom. In an exemplary arrangement, the container units of FIG. 4 may be 285 mm in length from one side of the cross to the other and 95 mm in width.

As shown, it would be appreciated that various arrangements and multiples of the container units of FIGS. 2A, 3, 4 may be arranged in a variety of arrangements within an enclosing base, and would not be limited to the specific depicted in FIG. 1.

Referring now to FIG. 5, there is shown an exemplary perspective view of the water impermeable base for the modular planting system 10. The base 18a includes engagement projections 17a as shown. It would be appreciated that these engagement projections 17a are sized and located about the base so as to at least partially receive and constrain the supporting member 24 and in turn the container units which extend around the supporting member 24.

In this way, the engagement projections retain the inserted container units in the desired location such that the whole arrangement of the container units may be moved collectively as a single unit.

It would be appreciated that the engagement projections may be sized appropriately to retain the abutting containers in a predetermined arrangement. The support member 24 may be received in the containers in such a way so that when the containers are on the base 18a, the support member 24 is maintained spaced apart from the upper surface of the base 18a by a predetermined separation distance. It would be appreciated that this predetermined separation distance should be appropriate so that the roots of the plants supported by the upper 25a and lower surface 25b of the support member can reach water contained in the water impermeable base. Of course, as a plant grows, the water level 89 in the water impermeable base could be adjusted so that only the lower surface of the support member 25b is able to be in communication with the water contained in the base. As would be appreciated by a person skilled in the art, the growing medium itself may be in contact with the water in the impermeable base through aperture(s) 29 or one or more surface(s) of the support member 25 to passively receive water by capillary action, or roots may communicate with the water by growing near to or through the apertures 29.

In this way, the container units and the plants contained therein can be maintained at a predetermined height above the water impermeable base such that depending on the considerations of evaporation, optimal plant water consumption preferences and the like, the water level 89 of the base may be adjusted accordingly.

It would be appreciated that this adjustment may be carried out by simply adding additional water to the base on an as-needed basis.

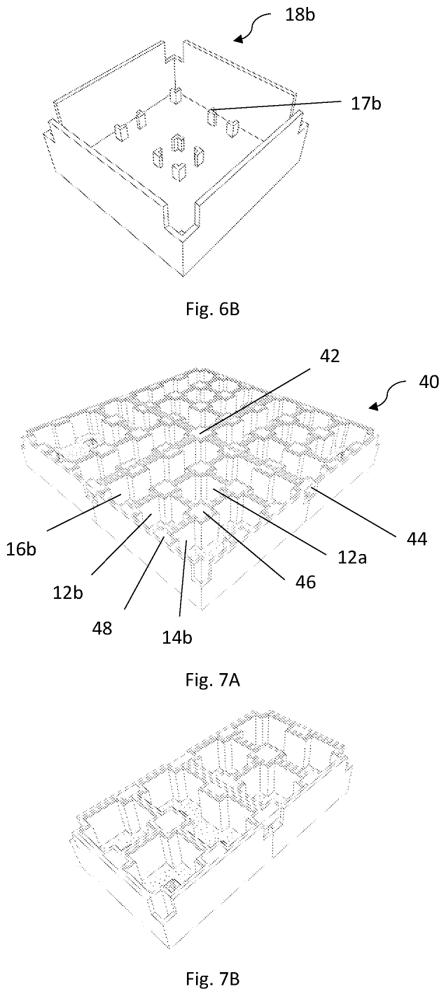

Referring now to FIG. 6A, there is depicted a further embodiment of the modular planting system 30, with overall size dimensioned according to a multiple of the container units, in the example depicted this multiple is twice the size of the container unit 12a, 12b. In an exemplary arrangement, the container units may be 95 mm in length from one side of the cross to the other and a similar dimension wide. In one exemplary embodiment, the length of the base may be 200 mm and the width may be also 200 mm. Other lengths of course would also be possible.

Referring to FIG. 6B, there is depicted a water impermeable base 18b with corresponding engagement projections 17b which are located at appropriate locations for receiving the planting containers and maintaining them in a predetermined arrangement when placed in the base.

Referring to FIG. 7A, 7B there is an arrangement comprising multiple modular planting systems of either FIG. 1 or FIGS. 6A and 6B.

As depicted in FIGS. 7A and 7B, the modular planting system 40 comprises a number of container units 12b (single), 14b (double), 16 (triple), each of these container units being one container unit wide. These container units are arranged above a water impermeable base 18a as depicted in the preceding FIGS. 5, 6A, 6B. Once the container units have been received in a water impermeable base 18a they are placed next to a similar arrangement of container units in a similar water impermeable base as shown in FIG. 7A. It would be appreciated that for such arrangements have been located in a generally square arrangement in the embodiment shown.

To provide structural rigidity to the arrangement shown, a block 46, 48 is inserted into the void between some adjacent container units. This block may be sized so as to extend substantially from the surface of the container unit down to the upper surface of the water impermeable base for transferring compressive forces from a vehicle or other heavy object down onto the base.

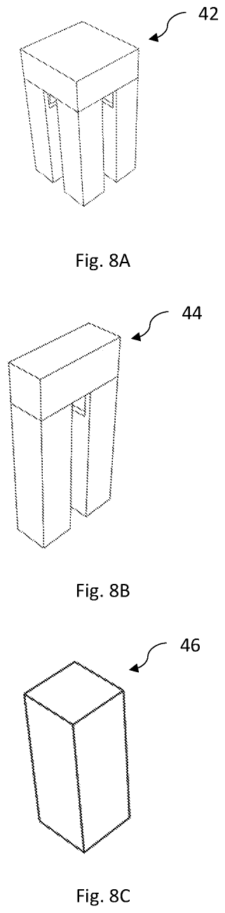

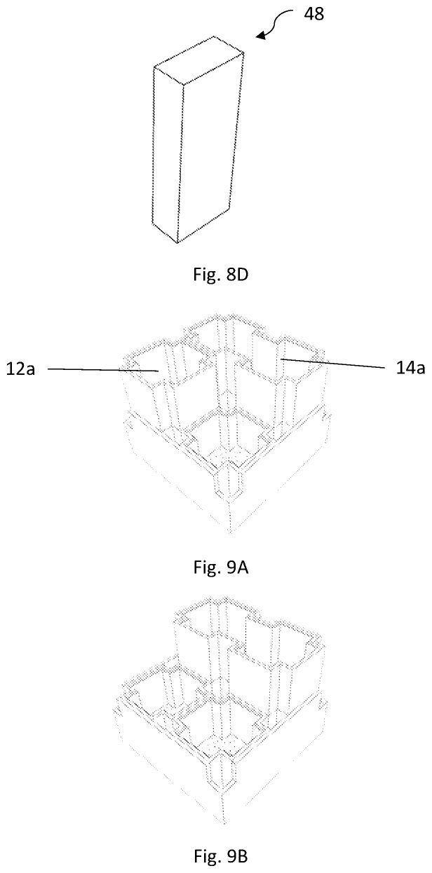

As depicted, the arrangement also includes a bridge 42, and a half bridge 44 used to facilitate the communication of water between adjacent systems. An exemplary configuration of such a bridge is depicted in FIGS. 8A and 8B. Exemplary configurations of the blocks 46, 48 are shown in FIGS. 8C and 8D.

The bridge and half bridge depicted in FIGS. 8A and 8B respectively may comprise an essentially hollow unit, in which wicking material may be inserted. Such wicking material may include fabric, jute, hessian, cotton or other types of materials which are suitable for transference of water by capillary action.

The bridges transfer water from one water impermeable bases to an adjacent unit. In the event that one of the bases depicted lacks water (e.g. through evaporation or the inclusion of thirsty plants in the containers), water from the adjacent container or containers may be picked up via the wicking material contained in the bridge mechanism and transferred to the adjacent container.

As depicted, the bridges and blocks of FIGS. 8A to 8D, may be sized to substantially occupy the voids formed between adjourning container units and thereby provide additional engagement and securing for the container units in the orientations in which they have been included in the water impermeable base.

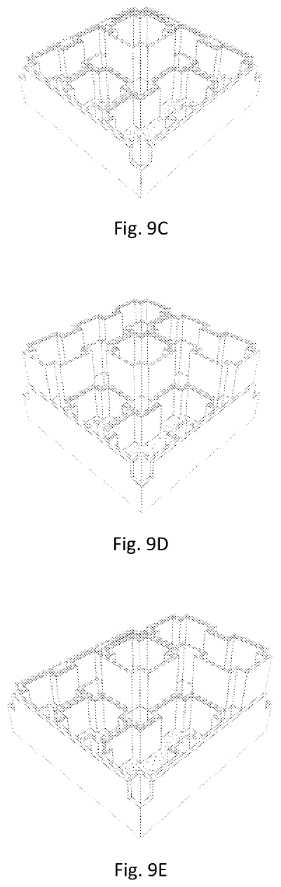

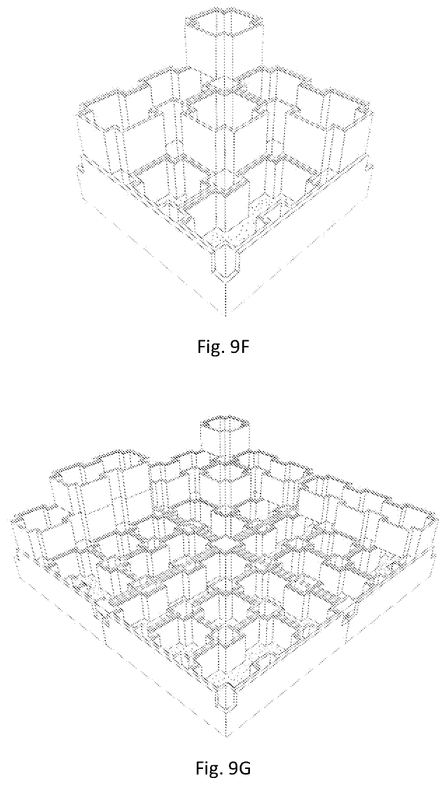

Referring now to FIGS. 9A to 9G, a variety of exemplary stacking arrangements are depicted for exemplary multiples of contiguous container units shown.

In FIG. 9A, a partially two-level arrangement is shown, with a single container unit 12a and a double container unit 14a placed side-by-side on top of a lower plurality of container units. This may then be received in a base (not shown).

Referring now to FIG. 9B, there is shown an alternate arrangement again partially two levels, with a different arrangement of container units.

FIG. 9C is a predominantly single level arrangement, with one container forming a second level at the back corner.

Similarly, in FIG. 9D, there is depicted a larger arrangement of multiple blocks, also partially two levels.

In FIG. 9E, a central and upper container unit is included.

In FIG. 9F, there are three potential levels depicted by stacking the containers.

While in FIG. 9G, a larger arrangement of adjacent systems, some of which are multiple levels have been included.

It would be appreciated that the modular planting system depicted allows flexibility in the arrangement of the container units, in terms of levels and sizes of container units located in the respective water impermeable bases. At the same time, the system enables a capacity to collectively move independent container units, ensures that all units have enough but not too much water for the plants and growing medium contained therein.

The stacking arrangement may be possible through locating projections or holes formed on the upper portion of each of the container units, which are insertable into corresponding apertures or projections formed in the base of the appropriate container units in the arrangements in an arrangement familiar to those persons skilled in the art.

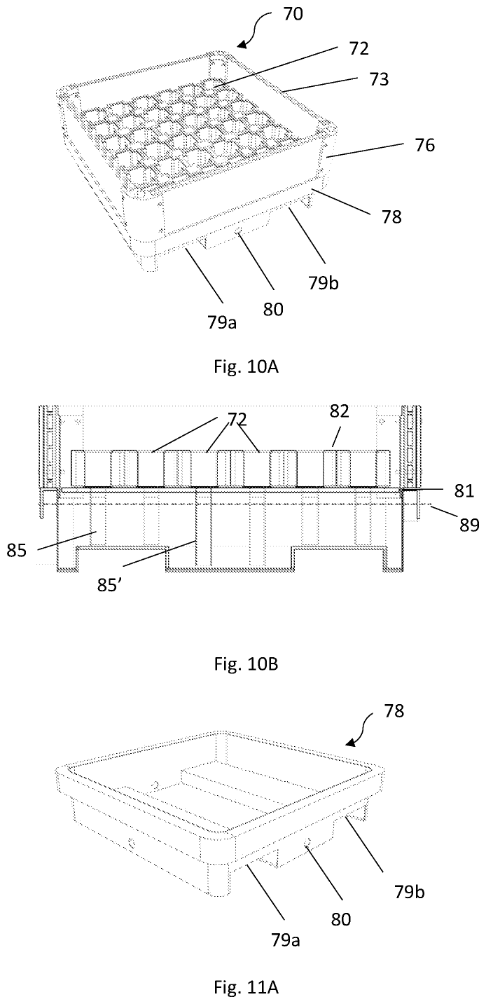

In a further aspect of the present disclosure, there is provided another exemplary modular planting system. FIG. 10A depicts a perspective view of the exemplary modular planting system 70. Similarly, as with the embodiment of FIGS. 1 to 9, the modular planting system contains a plurality of container units 72, supported on a water impermeable base 78. Sidewalls 73 extend between joint members 76 about the base to provide additional protection. There is also an opening 80 for fluid communication either for drainage or attachment to an adjacent modular planting system (not shown). In an exemplary arrangement, the planting system of FIG. 10A may be 680 mm in length, 680 mm in width and 297 in height. It would be appreciated that other dimensions would also be possible.

Recesses 79a, 79b may also be included in the water impermeable base 78. Advantageously, these recesses may be sized and located so as to be spaced apart so as to receive forklift tines. Through the inclusion of these recesses 79a, 79b, the modular planting system, even when fully loaded with plants and growing medium, may be transported from place to place using a forklift.

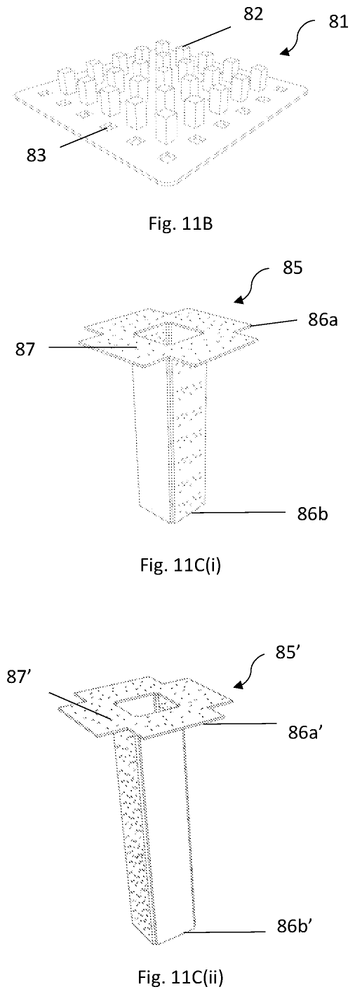

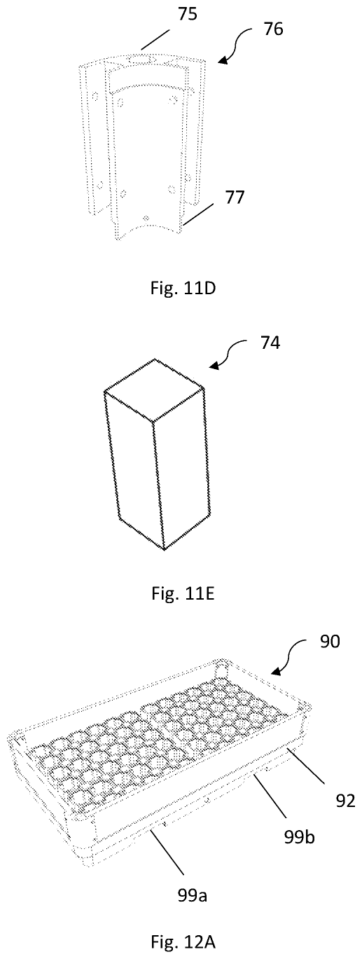

Referring now to FIG. 10B, there is depicted a cross section of the modular planting system 70 of FIG. 10A, in which the containers 72 define adjacent voids 73 in which the engagement projections 82 which extend from the frame 81 are received. Also, formed in the supporting frame 81 and discussed in more detail with reference to FIG. 11B, are a plurality of apertures 83. Supporting members 85, 85′ may be received in apertures 83, with these supporting members 85, 85′ being shown in more detail in FIG. 11C(i) and FIG. 11C(ii).

Referring to FIG. 11A, the various components of the modular planting system depicted in FIGS. 10A and 10B are described in more detail.

The substantially water impermeable base 78 is depicted in FIG. 11A. As mentioned in reference to FIG. 10A, the recesses 79a, 79b, are sized and configured to receive the tines or forks of a forklift. Referring now to FIG. 11B, the frame member which is not visible in FIG. 10A, but is shown in sectional view in FIG. 10B is discussed in more detail.

The frame 81 includes a plurality of projections 82 which are configured in an arrangement to engage the adjacent voids defined between the plurality of containers inserted onto the board. Also included in the frame 81 are a plurality of apertures 83, said apertures being positioned so as to be underneath the container units. These apertures are dimensioned in size to receive a support member 85 depicted in FIG. 11C(i) and a support member 85′ depicted in FIG. 11C(ii), the support member 85 comprising at least a first surface 86a at a first height and a second surface 86b at a second height. Similarly, the support member 85′ comprises at least a first surface 86a′ at a first height and a second surface 86b′ at a second height. In an exemplary arrangement, the supporting member 85′ is around 142 mm in height while the supporting member 85 is around 105 mm in height. It would be appreciated that other dimensions could also be possible.

In this way, the containers and growing medium and plants contained therein are able to contact the volume defined in the water impermeable base, through the apertures 87, 87′ defined in the support member 85, 85′ received in the apertures 83 of the frame 81. Hence, the engagement of projections 82 with the container units 72 position the units 72 (and supporting members therein) above corresponding apertures 83 in the frame 81 so that the wicking capacity provided by the supporting member 85 are in communication with water retained in the base.

It will also be appreciated that the supporting member 85 includes a plurality of apertures 87 formed therein, such that water within the volume defined by the substantially water impermeable base is able to be lifted through the supporting member and growing medium therein and be provided to water plants. Alternatively, as would be appreciated by a person skilled in the art, the growing medium itself may be in contact with the water in the impermeable base via apertures 87 or one or more surface(s) 86a, 86b of the support member 85 to passively receive water by capillary action.

In this way, it would be appreciated that the supporting member 85, is similar in the supporting member depicted in FIG. 2C.

Again, the interaction between the frame 81, the supporting member 85 and the base is such that the container units are received in the base on the frame via the engagement projections and the frame is supported on the base so that the supporting members are maintained in a predetermined distance spaced apart from the upper surface of the water impermeable base. This arrangement ensures that the roots of the plant and the lower portions of the supporting member are provided with enough water, and not too much water, depending on the water level 89 provided in the substantially water impermeable base. As will be appreciated by persons skilled in the art, it is critical that the plants in the containers have the appropriate amount of water for their climatic conditions and preferences, with too much water being detrimental to plant growth as well as having too little water.

Referring now to FIG. 11D, there is depicted an exemplary joint member 76 which together with walls 73 can provide further protection for the plants and containers arranged on the base. The joint member joins and holds the walls to form a single deck growing medium fence. The joint member may also be stackable to provide for the formation of taller fence around the base 78. A circular hole 75 of the joint member 76 optionally may be included to serve as a receiving end for the insertion of poles or other rigs such as columns for the construction of a greenhouse structure to protect the plants and plant material of the containers from pests such as insects or birds. It would be appreciated by a person skilled in the art, that the lower lip 77 of the joint member 76 may be configured to be received by the water impermeable base 78 such that the joint is precisely located in each of the corner positions of the water impermeable base 78.

FIG. 11E depicts an exemplary representation of a block 74 used to insert into the voids defined between a plurality of adjacent container units which provides further support and maintains the container units in the predetermined arrangement.

FIG. 12A depicts a further embodiment of the modular planting system 90, in this case adjoining modular planting systems of FIG. 10A.

An appropriately sized substantially water impermeable base 92 is shown in FIG. 12B, again with the spaced apart recesses 99a, 99b. It would be appreciated that depending on the load to be carried, the size of the forklift required (and hence the spacing of the tines) would be determined.

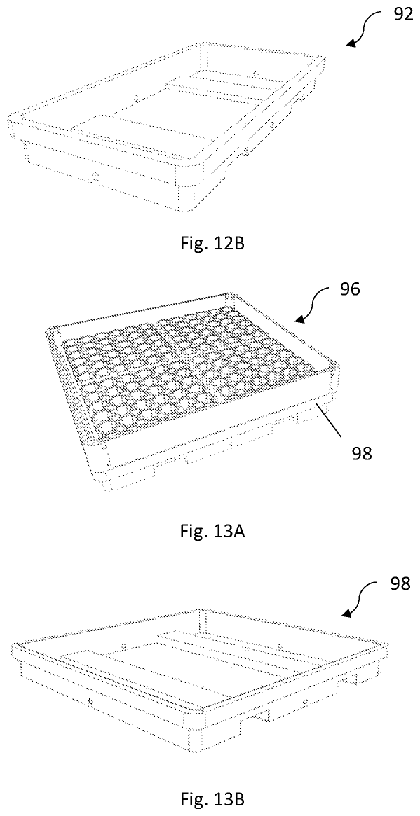

Referring to FIG. 13A, there is depicted yet a further exemplary arrangement 96 of multiple modular planting systems 90 depicted in FIG. 10A, in this case four units arranged side-by-side.

FIG. 13B depicts a corresponding substantially water impermeable base 98 sized appropriately.

It would be appreciated that the same container units as depicted in FIGS. 1 to 3 could be used in the modular planting systems depicted in FIGS. 10A to 13B.

Similarly, a variety of arrangements would be possible, depending on the particular container units selected, including where the container units are multiple tines, a single container unit for example 1, 2, 3, 4.

Advantageously, as with the previous embodiments, the container units could be contiguous multiples of the single container unit, with the intervening walls removed so as to form a single container unit.

Similarly, it would be appreciated that part or some of the systems may be stackable, depending on the desired arrangement.

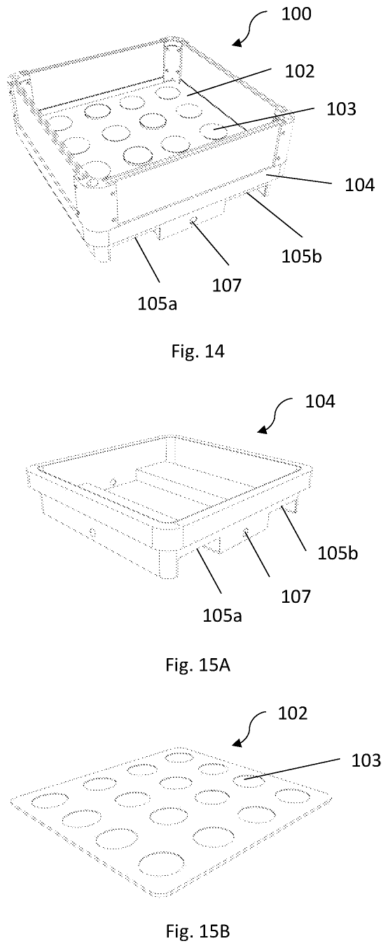

Referring now to yet a further embodiment as depicted in FIG. 14 of the modular planting system 100. In the embodiment depicted, there is included a frame 102 in which a plurality of aperture 103 are formed. The frame 102 is received in the water impermeable base 104 and may include joint members and wall as depicted. In an exemplary arrangement, the base 104 is 680 mm in length, 680 mm in width and 150 mm in height. Optionally, an additional side wall may be included which may be approximately 147 mm in height. It would be appreciated that other dimensions may also be possible.

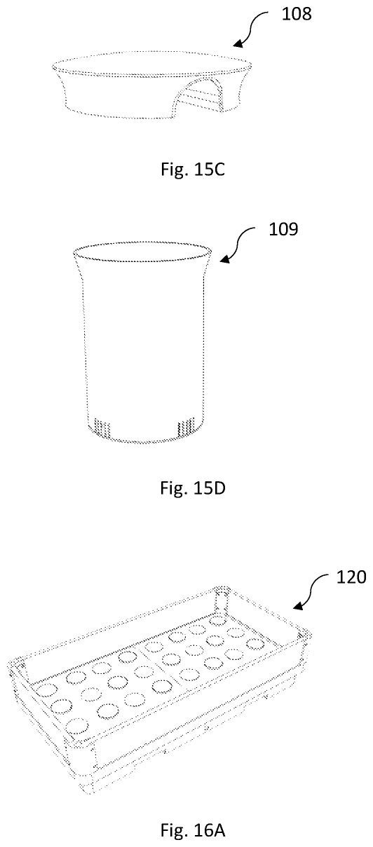

Referring now to FIG. 15A, there is depicted the substantially water impermeable base 104 for the modular planting system 100 shown in FIG. 14. Again, the substantially water impermeable base may include recesses 105a, 105b, so as to receive forklift tines.

An opening 107 could also be included for drainage or fluid communication with an adjacent planting system.

Referring now to FIG. 15B, the frame is depicted in more detail. It can be seen that the frame 102 essentially consists the plurality of holes 103, configured for receiving the container units depicted in FIG. 15D.

So as to limit the evaporation from the holes or apertures 103 formed in the frame, an exemplary cap 108 may also be included so as to temporarily close off the holes, in the event that the container units 109 is not inserted in the frame 102.

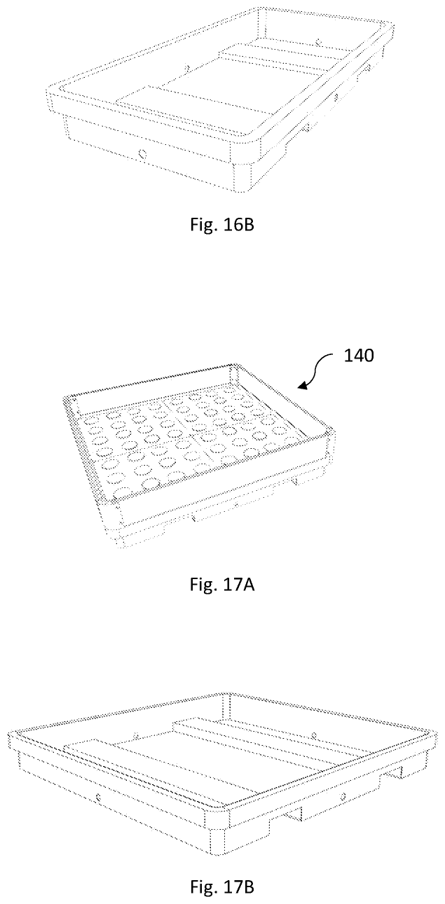

As depicted in FIG. 16A, multiple adjacent arrangements of the modular planting system 120 of FIG. 14 may also be included with appropriately sized substantially water impermeable bases as depicted in FIG. 16B included. In an exemplary arrangement, the planting system of FIG. 16A may be 1300 mm in length, 680 mm in width and 297 in height. It would be appreciated that other dimensions would also be possible.

Referring now to FIG. 17A, there is depicted yet a further embodiment of an arrangement of the modular planting system depicted in FIG. 14, in which for adjacent systems 140 are arranged side-by-side, similarly such systems are arranged on a substantially water impermeable base 144 as depicted in FIG. 17B. In an exemplary arrangement, the planting system 140 of FIG. 17A may be 1300 mm in length, 1300 mm in width and 297 mm in total height from the base (including an optional side wall member). It would be appreciated that other dimensions may also be possible.

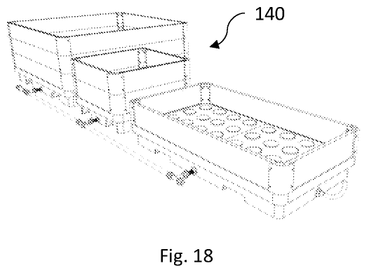

It would be appreciated that the systems depicted in FIGS. 14 to 17, could be arranged in a variety of configurations as depicted in the exemplary arrangement 150 shown in FIG. 18, in this arrangement, it can be seen that the two adjacent arrangements of the modular planting system 120 of FIG. 16A are adjacent to be single modular planting system 100 of FIG. 14, and the four modular planting systems 140 of FIG. 17A. These modular planting systems are connected by a pipe to distribute water.

One of the exemplary present systems advantageously enables feasible planting within limited space, like a balcony or where water/growing medium is not suitable for plant growing. Such planting system enables water stored in a reservoir to have a maximized efficiency in watering and at the same time the system may be easily relocated to other places when desired. For the planting systems discussed above with a relatively small size, such systems could be used as a desk decoration with variable combinations of different settings as desired.

Advantageously, the planting system of the present disclosure allows for easy assembly, disassembly and transportation, especially in a stackable configuration.

The above embodiments are described by way of example only. Many variations are possible without departing from the scope of the invention as defined in the appended claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A modular planting system comprising:
a plurality of container units for receiving therein growing medium and one or more plants or plant material, said containers being configured such that adjacent abutting containers define at least one or more voids therebetween;
a supporting member receivable inside each of the plurality of container units having at least a lower surface at a first height and an upper surface at a second height, wherein the second height is different from and greater than the first height; and wherein at least one of surfaces are water permeable;
a water impermeable base defining a volume for receiving therein the plurality of containers; and
a plurality of engagement projections extending from the water impermeable base configured to receive at least one supporting member of at least one container unit so as to maintain said at least one container unit in a predetermined arrangement wherein the lower surface of the supporting member is spaced apart from an upper surface of the water impermeable base by a predetermined separation distance.

2. A modular planting system according to claim 1, wherein the cross section of the containers and the supporting members received therein are substantially cross shaped.

3. A modular planting system according to claim 1, wherein the container units are sized as contiguous multiples of a single container unit.

4. A modular planting system according to claim 3, wherein the container units are configured as double, triple and quadruple multiples of a single container unit.

5. A modular planting system according to claim 4, wherein the container units are configured as double, triple and quadruple multiples of a single container unit along one direction and one single container unit in a direction orthogonal thereto.

6. A modular planting system according to claim 1, wherein the plurality of containers are configured such that the containers are multiples of a common unitary container so as to substantially extend along the predetermined dimensions of the base.

7. A modular planting system according to claim 1 wherein the system further comprises a member configured for interengaging adjacent modular planting systems and defining a pathway for passive fluid communication between adjacent modular planting systems.

8. A modular planting system according to claim 1 wherein the system further comprises a block member for reinforcing the at least one or more voids between adjacent container units.

9. A modular planting system according to claim 1 wherein the system comprises a single container unit having a size of 95 mm in width, 95 mm in length and 64 mm in height and having a cross sectional shape of a rectangle from which 16.0 mm squares have been removed from each corner thereof.

10. A modular planting system comprising:
a plurality of container units for receiving therein growing medium and one or more plants or plant material, said container unit being configured such that adjacent abutting container units define at least one or more voids therebetween;
a frame with a plurality of engagement projections extending at least partially into the at least one or more voids defined between adjacent abutting container units to maintain said container units in the abutting arrangement and positioned above apertures defined in the support frame member; and
a water impermeable base configured for supporting the frame spaced apart by a predetermined distance from an upper surface of the water impermeable base.

11. A modular planting system according to claim 10 wherein at least one or more of the plurality of container units includes therein a supporting member defining at least a lower surface at a first height and an upper surface at a second height, wherein the second height is different from and greater than the first height; and wherein at least one of surfaces are water permeable and wherein said supporting member extends through the apertures defined in the frame toward the water impermeable base.

12. A modular planting system according to claim 10 wherein the cross section of the containers and the supporting members received therein are substantially cross shaped.

13. A modular planting system according to claim 10 wherein the container units are sized as contiguous multiples of a single container unit.

14. A modular planting system according to claim 13 wherein the container units are sized n times a single container unit, wherein n is a natural number from 1-4.

15. A modular planting system according to claim 10 wherein the engagement projections have a predetermined length such that when received in the void defined between adjacent abutting containers the engagement projections extend near to the level of the uppermost surface of the plurality of containers.

16. A modular planting system according to claim 10 wherein the water impermeable base includes at least two recesses therein sized and spaced apart for receiving the tines of a forklift therein.

17. A modular planting system according to claim 10 wherein the system further includes a block member for reinforcing the at least one or more voids between adjacent containers.

18. A modular planting system according to claim 10 wherein the water impermeable base includes an aperture formed therein for fluid communication with an adjacent modular planting system.

19. A modular planting system according to claim 10 further including removable side members extending between corner portions, wherein said corner portions include at least one aperture for receiving either a least one pole or a locating member extending from a water impermeable base of another modular planting system.

20. A modular planting system according to claim 10 wherein the system comprises a single container unit having cross sectional shape of a square of 680 mm in width and 680 mm in length and having 297 mm in height.
